(19) United States
(12) Patent Application Publication
(10) Pub. No.: US 2025/0043775 A1
(43) Pub. Date: Feb. 6, 2025

(54) BUILDING WITH INTEGRATED ENERGY GENERATION AND STORAGE

(71) Applicant: Energy Tower, Inc., Pasadena, CA (US)

(72) Inventors: William Tod Gross, Pasadena, CA (US); Andrea Pedretti, Thousand Oaks, CA (US)

(21) Appl. No.: 18/786,072

(22) Filed: Jul. 26, 2024

Related U.S. Application Data
(60) Provisional application No. 63/516,778, filed on Jul. 31, 2023.

(51) Int. Cl. F03G 3/00; F25B 30/06; H02S 20/26; H02S 40/44

(52) U.S. Cl. CPC F03G 3/094; F25B 30/06; H02S 20/26; H02S 40/44

(57) ABSTRACT

A residential or commercial building has an integrated energy generation and storage system. Photovoltaic (PV) panels on the roof and/or side(s) of the building generate electricity from sunlight. The building includes an energy storage and delivery system includes blocks that can be raised from a lower elevation to a higher elevation to store energy as potential energy of the blocks, and that can be lowered from the higher elevation to the lower elevation to generate electricity. The generated electricity can be used to power systems or appliances in the building. A heat pump is powered by electricity generated by the PV panels and/or the energy storage system to charge a hot thermal energy storage for use in providing hot water or central heating to the building, and to charge a cold thermal energy storage for use in providing central air conditioning to the building.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field

The present disclosure is directed to a residential or commercial building, and more particularly to a residential or commercial building with integrated energy generation and storage.

### Description of the Related Art

There is an increased focus on reducing the use of fossil fuels to reduce the greenhouse gas emissions to the atmosphere. Photovoltaic panels have been installed on homes and buildings to generate electricity. However, such panels provide intermittent power as they can only generate power during daytime and are unable to provide power at night.

### SUMMARY

Accordingly, there is a need for improved residential or commercial buildings that can be powered continuously by renewable energy sources, even at night. In accordance with one aspect of the disclosure, a residential or commercial building with integrated energy generation and storage is provided.

In accordance with one aspect of the disclosure, a residential or commercial building is provided with an integrated energy generation and storage system. The building can include photovoltaic (PV) panels that generate electricity from sunlight. The PV panels can be installed on the roof of the building. Additionally or alternatively, PV panels can be installed on window awnings, such as south facing window awnings of the building (if in the northern hemisphere) and/or north facing window awnings of the building (if in the southern hemisphere). The building includes an energy storage system operable to generate electricity when desired (e.g., at night when PV panels do not generate electricity, during daytime if the building experiences a surge in power demand, such as during an excessive heat event). The energy storage system can include one or more blocks that can be raised from a lower elevation to a higher elevation to store energy as potential energy of the blocks, and that can be lowered from the higher elevation to the lower elevation to generate electricity. The block(s) can be raised and lowered with one or more elevators that travel along one or more elevator shafts of the building, the elevator(s) operatively coupled to a motor-generator. The motor-generator operates as a motor to raise block(s) to the higher elevation to store energy as potential energy. The motor-generator operates as a generator when the block(s) are lowered (e.g., under force of gravity) from the higher elevation to the lower elevation, and the generated electricity can be used to power systems or appliances in the building (e.g., lighting, elevators that carry people, electric appliances, etc.). The building can also include a heat pump powered by electricity generated by the PV panels and/or the energy storage system. The heat pump can be operated to provide heat or cooling to the building (e.g., hot water, central air heating, central air conditioning), for example by charging a hot thermal energy storage unit and cold thermal energy storage unit of the building.

In some aspects, the techniques described herein relate to a building with integrated energy generation and storage, including: one or more photovoltaic (PV) panels disposed on a roof of the building; one or more photovoltaic (PV) panels disposed on or forming window awnings for windows on one or more sides of the building, the PV panels on the roof and PV panels on the one or more sides of the building operable to generate electricity during daytime; an energy storage and delivery system including: a plurality of blocks; one or more elevators for blocks configured to travel along a shaft of the building between a lower floor and a higher floor of the building, each of the one or more elevators configured to carry one or more of the blocks; and a motor-generator operatively coupled to the one or more elevators, the motor-generator operable to raise one or more of the blocks with the one or more elevators to the higher floor to store energy based on a potential energy of the block at the higher floor relative to the lower floor, and lower one or more of the blocks with the one or more elevators from the higher floor to the lower floor to generate electricity, and a heat pump operable to charge a hot thermal storage and a cold thermal storage of the building, wherein the heat pump is operated with one or both of the generated electricity from the PV panels during daytime and the generated electricity from the energy storage and delivery system.

In some aspects, the techniques described herein relate to a building with integrated energy generation and storage, including: one or more photovoltaic (PV) panels disposed on a roof of the building or disposed on or forming window awnings for windows on one or more sides of the building, the PV panels operable to generate electricity during daytime; an energy storage and delivery system including: one or more elevators for blocks configured to travel along a shaft of the building between a lower floor and a higher floor of the building, each of the one or more elevators configured to carry one or more of blocks from the lower floor to the higher floor or from the higher floor to the lower floor; and a motor-generator operatively coupled to the one or more elevators, the motor-generator operable to raise one or more of the blocks with the one or more elevators to the higher floor to store energy based on a potential energy of the block at the higher floor relative to the lower floor, and lower one or more of the blocks with the one or more elevators from the higher floor to the lower floor to generate electricity, and a heat pump operable to charge a hot thermal storage and a cold thermal storage of the building, wherein the heat pump is operated with one or both of the generated electricity from the PV panels during daytime and the generated electricity from the energy storage and delivery system.

In some aspects, the techniques described herein relate to a method of generating electricity and storing and delivering electricity in a building, including: generating electricity during daytime with one or more photovoltaic (PV) panels disposed on a roof of the building or disposed on or forming window awnings for windows on one or more sides of the building; operating an energy storage and delivery system in the building, including raising one or more blocks with one or more elevators of the building to a higher floor to store energy based on a potential energy of the block at the higher floor relative to a lower floor, a motor-generator operatively coupled to the one or more elevators, and lowering one or more of the blocks with the one or more elevators from the higher floor to the lower floor to generate electricity with the motor-generator; operating a heat pump to charge a hot thermal storage and a cold thermal storage of the building using one or both of the generated electricity from the PV panels during daytime and the generated electricity from the energy storage and delivery system.

### BRIEF DESCRIPTION OF THE DRAWINGS

FIG. 1 is a schematic view of a building.

FIG. 2 is a cross-section of the building of FIG. 1 along line 2-2.

FIG. 3 is a diagram of systems of the building in FIG. 1.

FIG. 4 is a schematic view of the energy storage system of the building in an energy storage mode of operation.

FIG. 5 is a schematic view of the energy storage system of the building in an energy generation mode of operation.

FIG. 6 is a block diagram of the energy storage and delivery system.

FIG. 7 is a schematic view of a controller of the energy storage and delivery system.

### DETAILED DESCRIPTION

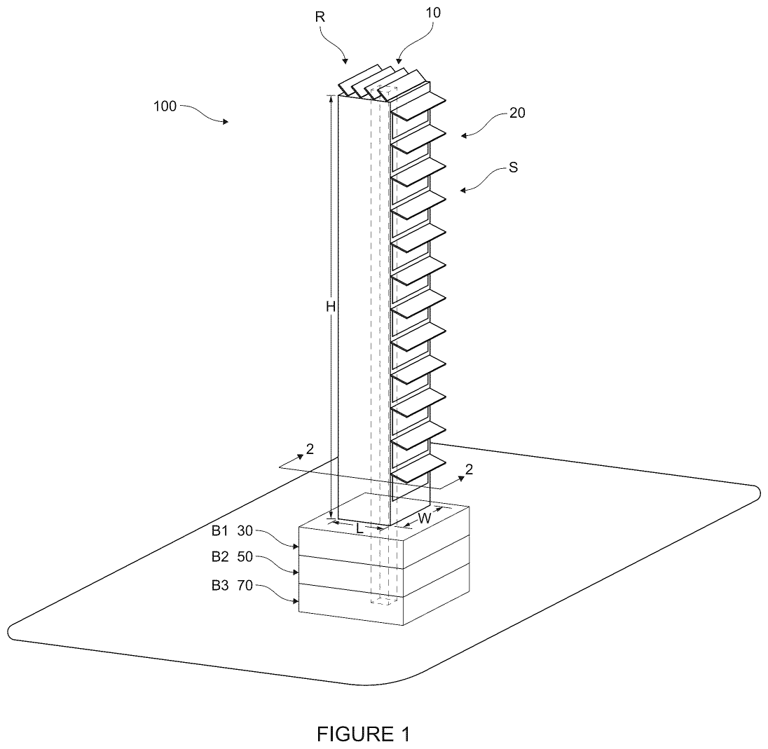

FIG. 1 shows a (residential and/or commercial) building with integrated energy generation and storage (hereafter “the building”) 100. The building 100 can have a height H, a length L and a width W. In one implementation, the length L and the width W are the same distance. In one implementation, the height H can be 200 meters, the length L can be 50 meters and the width W can be 50 meters. However, the building can have other suitable dimensions for the height H, length L and width W. The building 100 can have one or more (e.g., multiple) photovoltaic (PV) panels 10 disposed on a roof R of the building 100. The building 100 can have one or more (e.g., multiple) photovoltaic (PV) panels 20 on one or more sides S of the building 100 (e.g., disposed on, attached to or forming window awnings for windows of the building 100). In one example, where the height H, length L and width W of building 100 are 200 meters, 50 meters and 50 meters, respectively, the PV panels 10 on the roof R can provide 2500 m² of electricity generating area, and the PV panels 20 on the side S can provide 2500 m² of electricity generating area for a total of 5000 m² of electricity generating area. The PV panels 10 can in one implementation generate about 500 kW of electrical power or electricity. The PV panels 20 can in one implementation generate about 500 kW of electrical power or electricity.

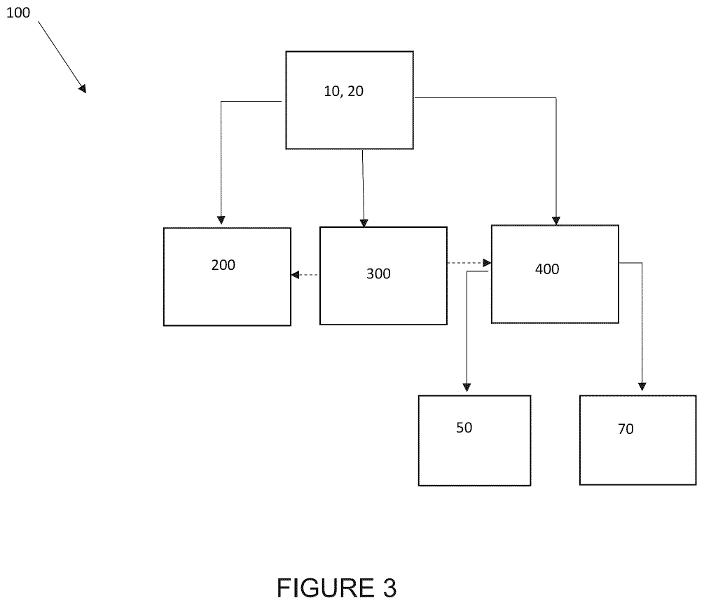

The building 100 can have a subfloor or basement floor B1 that provides a storage space 30 of weights 35 for an energy storage and delivery system 300 (see FIG. 3), as further discussed below. As further discussed below, the energy storage and delivery system 300 can, in one example, provide six hours of effective energy storage and delivery, and therefore can provide 3 MW-hr (e.g., 6 hr×500 kW) of electrical power or electricity from the PV panels 10 on the roof R of the building 100 and can provide 3 MW-hr (e.g., 6 hr×500 kW) of electrical power or electricity from the PV panels 20 on the side(s) S of the building 100, for a total of 6 MW-hr of electrical power or electricity (per day). However, in other implementations, the energy storage and delivery system 300 can provide energy storage and delivery for a different amount of time (e.g., 8 hours, 10 hours, 12 hours of effective energy storage and delivery).

The building 100 can have a subfloor or basement floor B2 (e.g., beneath basement floor B1) for hot thermal storage. The building 100 can have a subfloor or basement floor B3 (e.g., beneath basement floor B1) for cold thermal storage.

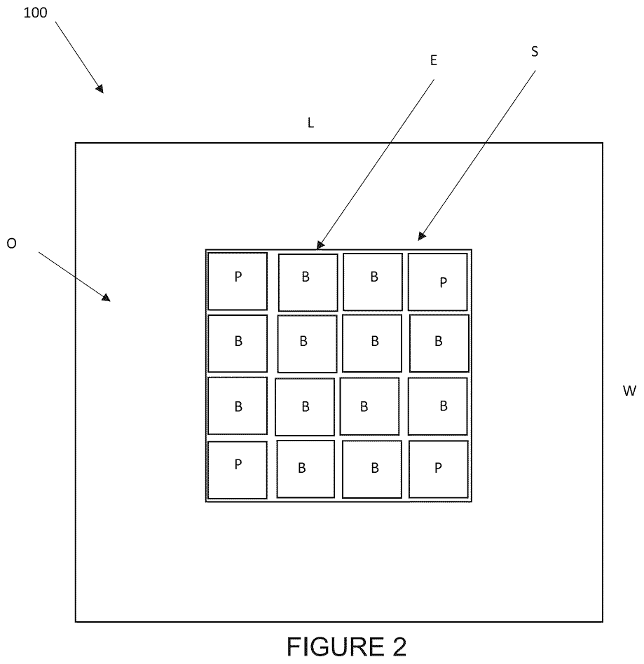

FIG. 2 shows a schematic cross-sectional view of the building 100 (e.g., at one floor of the building 100 for occupants). The building S can have one or more shafts S for elevators E (e.g., that extend linearly along at least a portion of the height H of the building 100). In one example, the building 100 can have one (e.g., have a single) central shaft S for (all of) the elevators E. In one example, where the length L and width W of the building 100 are 50 m×50 m, the cross-sectional area of the central shaft S can be 25 m×25 m. The elevators E and include elevators for transporting blocks B as part of the energy storage and delivery system 300 (discussed further below) and elevators for transporting people P between floors of the building 100. In the illustrated example, the building 100 has four elevators E for people P and twelve elevators for blocks B. However, one of skill in the art will recognize that the building 100 can have different numbers of elevators E for people P and blocks B. In another example, the building 100 can have five elevators E for people P and ten elevators E for blocks B. Surrounding the one or more shafts (e.g., the central shaft) S is occupant space (e.g., offices, residences) that face the windows of the building 100.

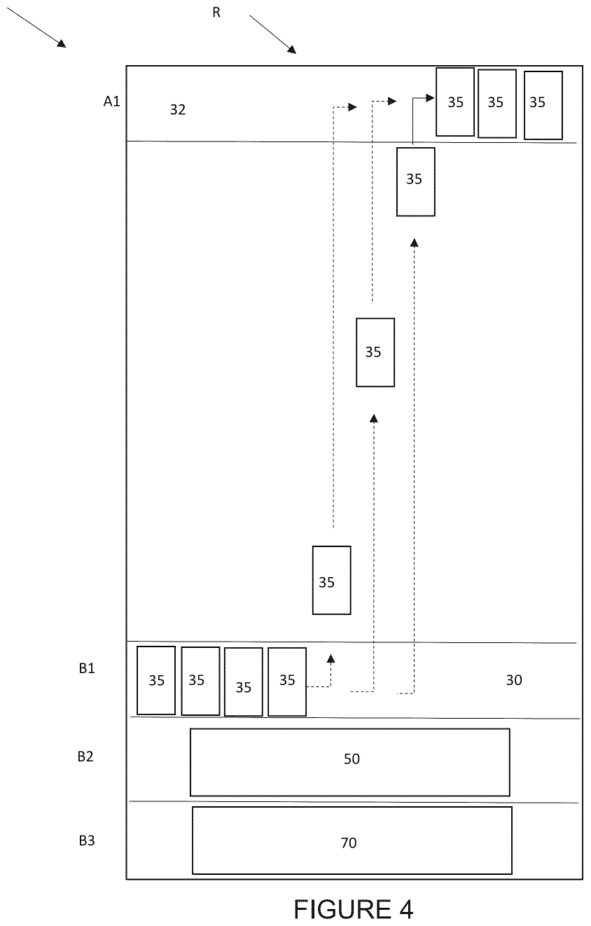

FIG. 3 shows a block diagram showing systems of the building 100. The PV panels 10, 20 can provide power to building systems 200 such as lighting, elevators E for people P, and electric appliances (e.g., connected to wall power outlets of the building 100). The PV panels 10, 20 can provide such power directly during daytime or daylight hours in an amount to cover all of the building's power demand, or can supplement power delivered to the building 100 from an electric grid. The PV panels 10, 20 can provide power (e.g., directly during daylight hours) to the energy storage and delivery system 300, for example to operate the energy storage and delivery system 300 in an energy storage mode to move blocks 35 (see FIG. 4) to a higher elevation (as further discussed below) in one or more of the elevators E for blocks B. The PV panels 10, 20 can provide power (e.g., directly during daylight hours) to a heat pump 400 to operate the heat pump 400 to store heat in a hot thermal energy storage 50 (e.g., to charge the hot thermal storage) and store cold energy (e.g., in the form of ice) in a cold thermal energy storage 70. The hot thermal energy storage 50 can be used to provide hot water and/or heating (e.g., central heating) for the building 100. The cold thermal energy storage 70 can be used to provide cooling (e.g., air conditioning) for the building 100.

FIG. 4 shows the energy storage and delivery system 300 of the building 100 in an energy storage mode of operation. In the energy storage mode, one or more blocks 35 are raised from the subfloor or basement floor B1 by one or more (e.g., multiple) of the elevators E for blocks B to floor A1 (e.g., located above all occupant floors, such as all offices or residences, and below the roof R) to store the blocks 35 on floor A1 for later power generation. The amount of power generation of each of the blocks 35 is their potential energy at floor A1 relative to subfloor or basement floor B1. Each block 35 can weigh between about 25 tons and about 35 tons. In one implementation, the elevators E for blocks B can carry one block 35 at a time (e.g., carry 25-35 tons at a time). In another implementation, the elevators E for blocks B can carry two blocks 35 at a time (e.g., carry 50-70 tons at a time). In one implementation, the blocks 35 can be made of concrete. However, the blocks 35 can be made of other suitable materials. In one example, all blocks 35 are raised from the subfloor or basement floor B1 to the floor A1. In another example, more than one basement subfloors can house blocks 35, which can be raised to multiple floors A1 at the top of the building 100.

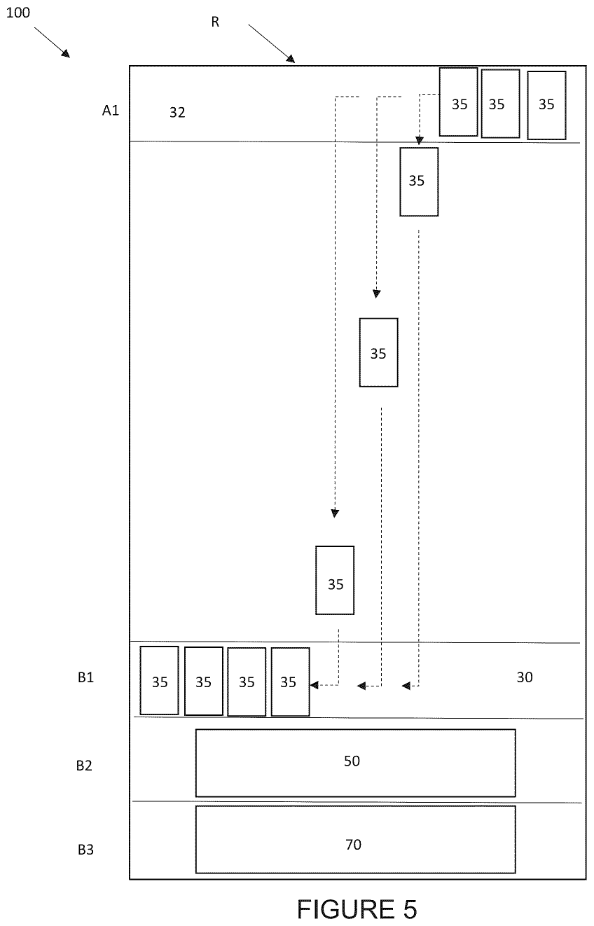

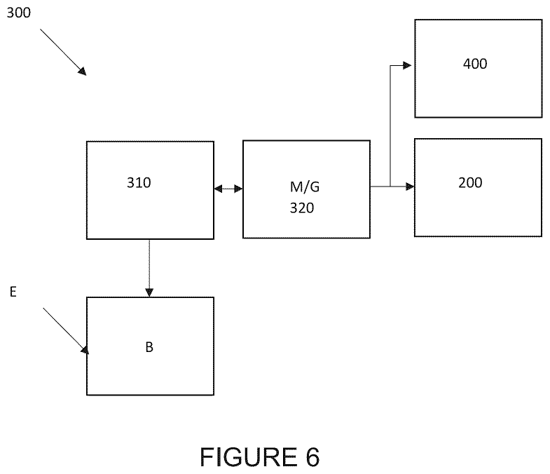

FIG. 5 shows the energy storage and delivery system 300 of the building 100 in an energy generation mode of operation. In the energy generation mode, one or more blocks 35 are lowered to the subfloor or basement floor B1 by one or more (e.g., multiple) of the elevators E for blocks B from floor A1 to store the blocks 35 on subfloor or basement floor B1. As each block 35 is lowered (e.g., at least partially under force of gravity), the elevator E lowering the block 35, which is operatively coupled to a motor-generator 320 (see FIG. 6), generates electricity via the motor-generator 320 that is supplied to the building 100. For example, the electricity generated by the motor-generator from lowering block(s) 35 can deliver electricity to building systems 200 such as lighting, elevators E for people P, and electric appliances or wall outlet power, and/or the heat pump 400 to operate the heat pump 400 to store heat in the hot thermal energy storage 50 and store cold energy (e.g., in the form of ice) in the cold thermal energy storage 70. The amount of power generated by motor-generator from the lowering of each of the blocks 35 is commensurate with the potential energy of the block 35 at floor A1 relative to subfloor or basement floor B1. Since each block 35 travels the same height between the floor A1 and subfloor or basement floor B1, each block 35 generates the same amount of electrical power when lowered from floor A1 to subfloor or basement floor B1. In one example, the building 100 can have a single motor-generator 320 operatively coupled to each of the elevators E for blocks B. In another example, each of the elevators E for blocks B can have an associated motor-generator 320.

The power generated by the energy storage and delivery system 300 is discontinuous, since it generates electricity as the block 35 is lowered, but consumes electricity as the empty elevator E for blocks B is raised to pick up another block 35. However, the multiple elevators E for blocks B can be operated (e.g., controlled at the same time, in a synchronous manner, under computer control) together to provide continuous power (e.g., one or more elevators E for blocks B generate electricity by lowering blocks 35, while other elevators E for blocks B systems are raised to pick up other blocks 35). In the example shown in FIG. 4, three blocks 35 are shown, each in some stage of travel during the lowering process for the blocks 35. In the illustrated example, as one block 35 is reaching the subfloor or basement floor B1, another block 35 (being lowered by another elevator E for blocks B) is at a higher elevation, and still another block 35 is just starting the lowering process (via another elevator for blocks B). Therefore, when the energy storage and delivery system 300 is operated in the energy generation mode, it is operated so that there is continuous power generation (e.g., there is no period of time when all of the elevators E for blocks B are not generating power).

FIG. 6 shows a block diagram of the energy storage and delivery system 300. The energy storage and delivery system 300 includes the motor-generator 320 operatively coupled to a winch 310, which is operatively coupled to an elevator E for a block B (e.g., via one or more cables that extend about a spool of the winch 310). When the block 35 is raised from the subfloor or basement floor B1 to floor A1 to store energy (e.g., based on the potential energy of the block 35 at floor A1 relative to basement floor B1), the motor-generator 320 operates as an electric motor to drive the operation of the winch 310 (e.g., rotation of the winch 310) to raise the elevator E carrying the block 35. When the block 35 is lowered to the subfloor or basement floor B1 from floor A1 to generate electricity, the motor-generator 320 operates as a generator and is driven by the winch 310 while lowering the block 35 to generate electricity from the lowering of the block 35 by the winch 310. The electricity generated is provided by the motor-generator 320, for example, to the heat pump 400 to operate the heat pump 400 to provide hot thermal energy storage 50 and cold thermal energy storage 70, as described above, and/or to building systems 200 such as lighting, elevators E for people P, and electric appliances or wall outlet power. In one implementation, the motor-generator 320 is operatively coupled to the winch 310 without a gear box. In another implementation, the motor-generator 320 can include a variable frequency drive, advantageously allowing the electric motor-generator 320 to rotate the winch 310 faster or slower, accelerate or decelerate (for example to wind or unwind the cables at different speeds based on the sensed position of the elevator E for blocks B) depending on whether the elevator E for blocks B is being raised or lowered carrying a block 35 or is being raised or lowered empty, or its vertical position in the building 100 (e.g., its position relative to the subfloor or basement floor B1 when the block 35 is being lowered, its position relative to the subfloor or basement floor B1 or floor A1 when the elevator E for blocks B is being lowered or raised empty).

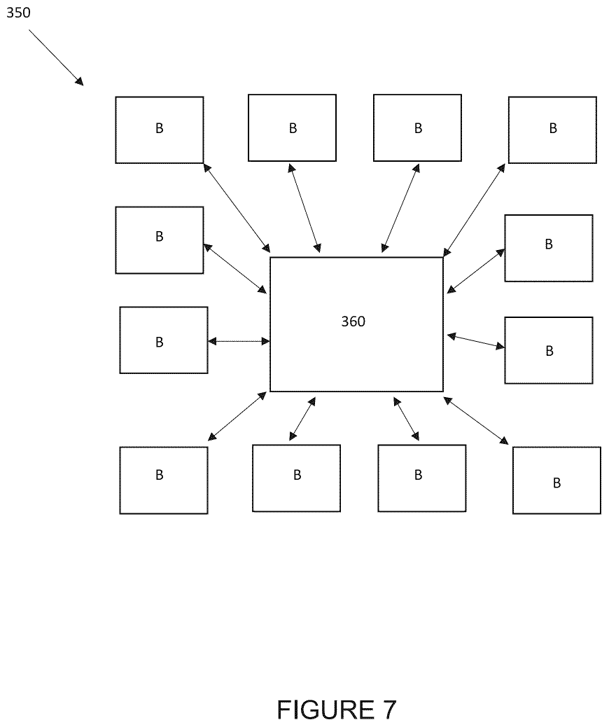

FIG. 7 shows a control system 350 for controlling the operation of the elevators E for blocks B of the energy storage and delivery system 300. In the illustrated example, based on the example in FIG. 2, there are twelve elevators E for blocks B. However, one of skill in the art will recognize that the system 300 can have fewer or more elevators E for blocks B than shown in FIG. 7. The elevators E for blocks B can be operated by a controller 360 at the same time. For example, the controller 360 can operate each of the elevators E for blocks B in a synchronous manner to provide continuous power generation, as discussed above. In one implementation, the controller 360 communicates with the elevators E for blocks B (e.g., with a controller for the motor-generator 320 and winch 310) via a wired connection. In another implementation, the controller 360 communicates with the elevators E for blocks B (e.g., with a controller for the motor-generator 320 and winch 310) via a wireless connection (e.g., via a transceiver on the elevators E for blocks B and the controller 360. The controller 360 can include one or more computer processors operable to execute one or more operating algorithms for the operation of the elevators E for blocks B of the energy storage and delivery system 300. In one example, the algorithms can be stored in a memory of the controller 360.

### Additional Embodiments

In embodiments of the present disclosure, a building with integrated energy generation and storage and method of operating the same may be in accordance with any of the following clauses:
Clause 1. A building with integrated energy generation and storage, comprising: one or more photovoltaic (PV) panels disposed on a roof of the building; one or more photovoltaic (PV) panels disposed on or forming window awnings for windows on one or more sides of the building, the PV panels on the roof and PV panels on the one or more sides of the building operable to generate electricity during daytime; an energy storage and delivery system comprising: a plurality of blocks; one or more elevators for blocks configured to travel along a shaft of the building between a lower floor and a higher floor of the building, each of the one or more elevators configured to carry one or more of the blocks; and a motor-generator operatively coupled to the one or more elevators, the motor-generator operable to raise one or more of the blocks with the one or more elevators to the higher floor to store energy based on a potential energy of the block at the higher floor relative to the lower floor, and lower one or more of the blocks with the one or more elevators from the higher floor to the lower floor to generate electricity, and a heat pump operable to charge a hot thermal storage and a cold thermal storage of the building, wherein the heat pump is operated with one or both of the generated electricity from the PV panels during daytime and the generated electricity from the energy storage and delivery system.
Clause 2. The building with integrated energy generation and storage of Clause 1, wherein the lower floor is a basement floor of the building.
Clause 3. The building with integrated energy generation and storage of any preceding clause, wherein the shaft is a central shaft of the building.
Clause 4. The building with integrated energy generation and storage of any preceding clause, wherein the hot thermal storage and the cold thermal storage are disposed in a basement floor of the building.
Clause 5. The building with integrated energy generation and storage of Clause 4, wherein the hot thermal storage and the cold thermal storage are disposed in separate basement floors of the building.
Clause 6. The building with integrated energy generation and storage of any preceding clause, wherein the generated electricity from the PV panels during daytime is used to raise the one or more blocks with the one or more elevators to the higher floor to store energy.
Clause 7. The building with integrated energy generation and storage of any preceding clause, wherein the hot thermal storage is in a floor below the lower floor.
Clause 8. The building with integrated energy generation and storage of any preceding clause, wherein the hot thermal storage provides one or both of hot water and central air heating to the building.
Clause 9. The building with integrated energy generation and storage of any preceding clause, wherein the cold thermal storage is in a floor below the lower floor and below a floor of the hot thermal storage.
Clause 10. The building with integrated energy generation and storage of Clause 9, wherein the cold thermal storage provides central air conditioning to the building.
Clause 11. The building with integrated energy generation and storage of Clause 9, wherein the cold thermal storage comprises ice.
Clause 12. A building with integrated energy generation and storage, comprising: one or more photovoltaic (PV) panels disposed on a roof of the building or disposed on or forming window awnings for windows on one or more sides of the building, the PV panels operable to generate electricity during daytime; an energy storage and delivery system comprising: one or more elevators for blocks configured to travel along a shaft of the building between a lower floor and a higher floor of the building, each of the one or more elevators configured to carry one or more of blocks from the lower floor to the higher floor or from the higher floor to the lower floor; and a motor-generator operatively coupled to the one or more elevators, the motor-generator operable to raise one or more of the blocks with the one or more elevators to the higher floor to store energy based on a potential energy of the block at the higher floor relative to the lower floor, and lower one or more of the blocks with the one or more elevators from the higher floor to the lower floor to generate electricity, and a heat pump operable to charge a hot thermal storage and a cold thermal storage of the building, wherein the heat pump is operated with one or both of the generated electricity from the PV panels during daytime and the generated electricity from the energy storage and delivery system.
Clause 13. The building with integrated energy generation and storage of Clause 12, wherein the lower floor is a basement floor of the building.
Clause 14. The building with integrated energy generation and storage of any of Clauses 12-13, wherein the shaft is a central shaft of the building.
Clause 15. The building with integrated energy generation and storage of any of Clauses 12-14, wherein the hot thermal storage and the cold thermal storage are disposed in separate basement floors of the building.
Clause 16. The building with integrated energy generation and storage of any of Clauses 12-15, wherein the generated electricity from the PV panels during daytime is used to raise the one or more blocks with the one or more elevators to the higher floor to store energy.
Clause 17. The building with integrated energy generation and storage of any of Clauses 12-16, wherein the hot thermal storage provides one or both of hot water and central air heating to the building.
Clause 18. The building with integrated energy generation and storage of any of Clauses 12-17, wherein the cold thermal storage provides central air conditioning to the building.
Clause 19. A method of generating electricity and storing and delivering electricity in a building, comprising: generating electricity during daytime with one or more photovoltaic (PV) panels disposed on a roof of the building or disposed on or forming window awnings for windows on one or more sides of the building; operating an energy storage and delivery system in the building, comprising raising one or more blocks with one or more elevators of the building to a higher floor to store energy based on a potential energy of the block at the higher floor relative to a lower floor, a motor-generator operatively coupled to the one or more elevators, and lowering one or more of the blocks with the one or more elevators from the higher floor to the lower floor to generate electricity with the motor-generator; operating a heat pump to charge a hot thermal storage and a cold thermal storage of the building using one or both of the generated electricity from the PV panels during daytime and the generated electricity from the energy storage and delivery system.
Clause 20. The method of Clause 19, wherein the raising of the one or more blocks is effected with generated electricity from the PV panels during daytime.

While certain embodiments of the inventions have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Of course, the foregoing description is that of certain features, aspects and advantages of the present invention, to which various changes and modifications can be made without departing from the spirit and scope of the present invention. Moreover, the devices described herein need not feature all of the objects, advantages, features and aspects discussed above. Thus, for example, those of skill in the art will recognize that the invention can be embodied or carried out in a manner that achieves or optimizes one advantage or a group of advantages as taught herein without necessarily achieving other objects or advantages as may be taught or suggested herein. In addition, while a number of variations of the invention have been shown and described in detail, other modifications and methods of use, which are within the scope of this invention, will be readily apparent to those of skill in the art based upon this disclosure. It is contemplated that various combinations or subcombinations of these specific features and aspects of embodiments may be made and still fall within the scope of the invention. Accordingly, it should be understood that various features and aspects of the disclosed embodiments can be combined with or substituted for one another in order to form varying modes of the discussed devices.

What is claimed is:

1. A building with integrated energy generation and storage, comprising:
one or more photovoltaic (PV) panels disposed on a roof of the building;
one or more photovoltaic (PV) panels disposed on or forming window awnings for windows on one or more sides of the building, the PV panels on the roof and PV panels on the one or more sides of the building operable to generate electricity during daytime;
an energy storage and delivery system comprising:
a plurality of blocks;
one or more elevators for blocks configured to travel along a shaft of the building between a lower floor and a higher floor of the building, each of the one or more elevators configured to carry one or more of the blocks; and
a motor-generator operatively coupled to the one or more elevators, the motor-generator operable to:
raise one or more of the blocks with the one or more elevators to the higher floor to store energy based on a potential energy of the block at the higher floor relative to the lower floor, and
lower one or more of the blocks with the one or more elevators from the higher floor to the lower floor to generate electricity, and
a heat pump operable to charge a hot thermal storage and a cold thermal storage of the building,
wherein the heat pump is operated with one or both of the generated electricity from the PV panels during daytime and the generated electricity from the energy storage and delivery system.

2. The building with integrated energy generation and storage of claim 1, wherein the lower floor is a basement floor of the building.

3. The building with integrated energy generation and storage of claim 1, wherein the shaft is a central shaft of the building.

4. The building with integrated energy generation and storage of claim 1, wherein the hot thermal storage and the cold thermal storage are disposed in a basement floor of the building.

5. The building with integrated energy generation and storage of claim 4, wherein the hot thermal storage and the cold thermal storage are disposed in separate basement floors of the building.

6. The building with integrated energy generation and storage of claim 1, wherein the generated electricity from the PV panels during daytime is used to raise the one or more blocks with the one or more elevators to the higher floor to store energy.

7. The building with integrated energy generation and storage of claim 1, wherein the hot thermal storage is in a floor below the lower floor.

8. The building with integrated energy generation and storage of claim 1, wherein the hot thermal storage provides one or both of hot water and central air heating to the building.

9. The building with integrated energy generation and storage of claim 1, wherein the cold thermal storage is in a floor below the lower floor and below a floor of the hot thermal storage.

10. The building with integrated energy generation and storage of claim 9, wherein the cold thermal storage provides central air conditioning to the building.

11. The building with integrated energy generation and storage of claim 9, wherein the cold thermal storage comprises ice.

12. A building with integrated energy generation and storage, comprising:
one or more photovoltaic (PV) panels disposed on a roof of the building or disposed on or forming window awnings for windows on one or more sides of the building, the PV panels operable to generate electricity during daytime;
an energy storage and delivery system comprising:
one or more elevators for blocks configured to travel along a shaft of the building between a lower floor and a higher floor of the building, each of the one or more elevators configured to carry one or more of blocks from the lower floor to the higher floor or from the higher floor to the lower floor; and
a motor-generator operatively coupled to the one or more elevators, the motor-generator operable to:
raise one or more of the blocks with the one or more elevators to the higher floor to store energy based on a potential energy of the block at the higher floor relative to the lower floor, and
lower one or more of the blocks with the one or more elevators from the higher floor to the lower floor to generate electricity, and
a heat pump operable to charge a hot thermal storage and a cold thermal storage of the building,
wherein the heat pump is operated with one or both of the generated electricity from the PV panels during daytime and the generated electricity from the energy storage and delivery system.

13. The building with integrated energy generation and storage of claim 12, wherein the lower floor is a basement floor of the building.

14. The building with integrated energy generation and storage of claim 12, wherein the shaft is a central shaft of the building.

15. The building with integrated energy generation and storage of claim 12, wherein the hot thermal storage and the cold thermal storage are disposed in separate basement floors of the building.

16. The building with integrated energy generation and storage of claim 12, wherein the generated electricity from the PV panels during daytime is used to raise the one or more blocks with the one or more elevators to the higher floor to store energy.

17. The building with integrated energy generation and storage of claim 12, wherein the hot thermal storage provides one or both of hot water and central air heating to the building.

18. The building with integrated energy generation and storage of claim 12, wherein the cold thermal storage provides central air conditioning to the building.

19. A method of generating electricity and storing and delivering electricity in a building, comprising:
generating electricity during daytime with one or more photovoltaic (PV) panels disposed on a roof of the building or disposed on or forming window awnings for windows on one or more sides of the building;
operating an energy storage and delivery system in the building, comprising:
raising one or more blocks with one or more elevators of the building to a higher floor to store energy based on a potential energy of the block at the higher floor relative to a lower floor, a motor-generator operatively coupled to the one or more elevators, and
lowering one or more of the blocks with the one or more elevators from the higher floor to the lower floor to generate electricity with the motor-generator; and
operating a heat pump to charge a hot thermal storage and a cold thermal storage of the building using one or both of the generated electricity from the PV panels during daytime and the generated electricity from the energy storage and delivery system.

20. The method of claim 19, wherein the raising of the one or more blocks is effected with generated electricity from the PV panels during daytime.
